(19) United States
(12) Patent Application Publication
(10) Pub. No.: US 2016/0091777 A1
(43) Pub. Date: Mar. 31, 2016

(54) FLASH MODULE WITH SHIELDING FOR USE IN MOBILE PHONES AND OTHER DEVICES

(71) Applicant: HEPTAGON MICRO OPTICS PTE. LTD., Singapore (SG)

(72) Inventors: Kam Pui Kuan, Skudai Johor (MY); Hakan Karpuz, Au (CH); Michel Barge, Aeugst am Albis (CH); Nicola Spring, Ziegelbrücke (CH); Robert Lenart, Zurich (CH)

(21) Appl. No.: 14/891,589

(22) PCT Filed: May 15, 2014
(86) PCT No.: PCT/SG2014/000212

§ 371 Date: Nov. 16, 2015

Related U.S. Application Data
(60) Provisional application No. 61/826,257, filed on May 22, 2013.

(51) Int. Cl. G03B 15/05

(52) U.S. Cl. CPC G03B 15/05

(57) ABSTRACT

A flash module comprises an optics portion that includes a base plate, a light guide on a first side of the base plate, and a lens element on a second side of the base plate. A casing is attached to the optics portion and defines an interior region in which the lens element is located. An active light emitting component is mounted within the casing. Sidewalls of the light guide are coated with first and second layers of different materials. The second layer is a coating over the first layer and is substantially non-transparent to light emitted by the active light emitting component. The first layer can provide a predetermined aesthetic appearance and can be selected, for example, to match the color of the exterior surface of a device in which the flash module is to be integrated.

### FIELD OF THE DISCLOSURE

This disclosure relates to flash modules with shielding that can be integrated, for example, into a mobile phone or other device.

### BACKGROUND

Smartphones and other devices sometimes include miniaturized optics such as a flash module. Flash modules can include a light emitting diode (LED) that emits light through a lens to outside the phone or other device. The flash module can be used, for example, in combination with a camera that is integrated into the phone.

As illustrated in FIG. 1, one challenge when integrating a flash module 10 into a device such as a smartphone is how to reduce light leakage 14 from the light source 16 in the flash module into the smartphone housing 18. Such light leakage can result in an undesirable appearance of the smartphone, particularly for smartphones that have a white or colored housing.

### SUMMARY

The present disclosure describes flash modules that have dual coating layers on sidewalls of a light guide. One of the coating layers can help reduce light leakage from the light guide, and the other coating layer can help improve aesthetic appearance.

For example, in one aspect, a flash module comprises an optics portion that includes a base plate, a light guide on a first side of the base plate, and a lens element on a second side of the base plate. A casing is attached to the optics portion and defines an interior region in which the lens element is located. An active light emitting component is mounted within the casing. Sidewalls of the light guide are coated with first and second layers of different materials. The second layer is a coating over the first layer and is substantially non-transparent to light emitted by the active light emitting component.

In some implementations, the first layer provides a predetermined aesthetic appearance and can be selected, for example, to match the color of the exterior surface of a device in which the flash module is to be integrated. The first layer thus can have either a white appearance or a colored appearance. In some implementations, the first layer is composed of a polyurethane-type material. The thickness of the first layer, the second layer, or each of the layers can be, for example, in the range of 10-20 microns, and in some implementations, is in the range of 5-40 microns. Other thicknesses may be appropriate for some implementations. The first side of the base plate (other than an area on which the light guide is disposed) also can be coated with the first and second layers.

According to another aspect, an electronic device (e.g., a mobile phone) includes a housing containing components of the electronic device and having a wall with an opening. A flash module, such as described above, is integrated within the housing. The light guide can be positioned within the opening in the wall of the housing so as to provide a channel for light from the flash module.

Yet another aspect describes a method of fabricating multiple optics systems in a wafer level process. The method includes forming light guide elements on a first side of a substrate that is substantially transparent to light of a particular wavelength or range of wavelengths. A first coating is applied on side surfaces of the light guide elements, and a second coating is applied over the first coating. The second coating is composed of a different material from the first coating and is substantially non-transparent to light of the particular wavelength or range of wavelengths. The method includes forming a plurality of lens elements on a second side of the substrate, wherein each lens element is substantially aligned with a corresponding one of the light guide elements. The substrate is separated into multiple optics systems each of which includes at least one of the light guiding elements and a corresponding number of the lens elements.

Various advantages can be obtained in some implementations. For example, the dual coating layers can help prevent light from the LED or other active light emitting component from leaking into the housing of the smartphone or other device and at the same time can help maintain or enhance the outer appearance of the smartphone or other device.

Other aspects, features and advantages will be readily apparent from the following detailed description, the accompanying drawings and the claims.

### BRIEF DESCRIPTION OF THE DRAWINGS

FIG. 1 illustrates an example of light leakage from a flash module into a smartphone housing.

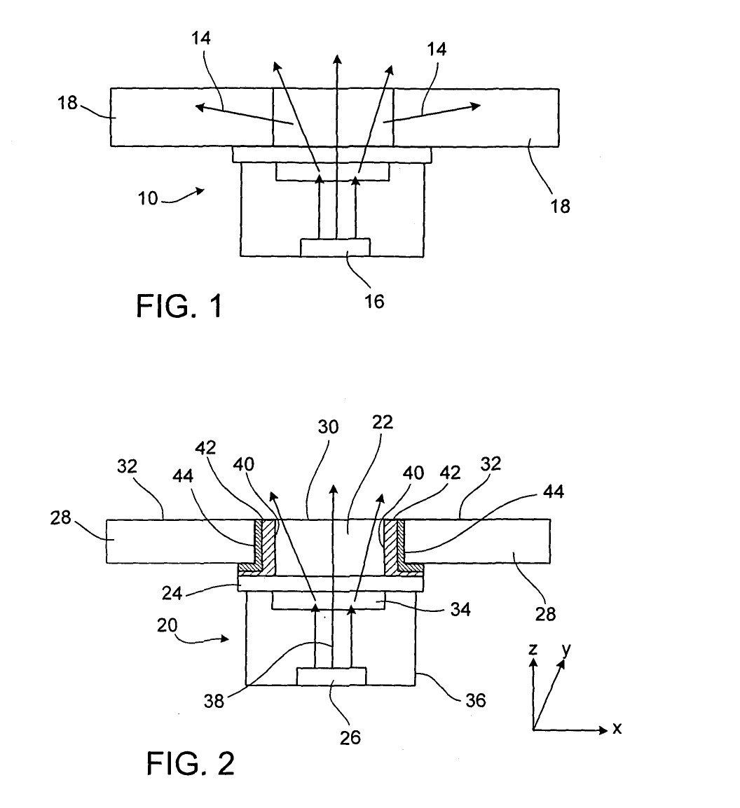

FIG. 2 illustrates an example of flash module in a smartphone housing according to the present disclosure.

FIG. 3 illustrates a perspective view of an example of a light guide that forms part of the flash module.

FIGS. 4-10 illustrate a wafer-level fabrication process for making multiple flash modules.

### DETAILED DESCRIPTION

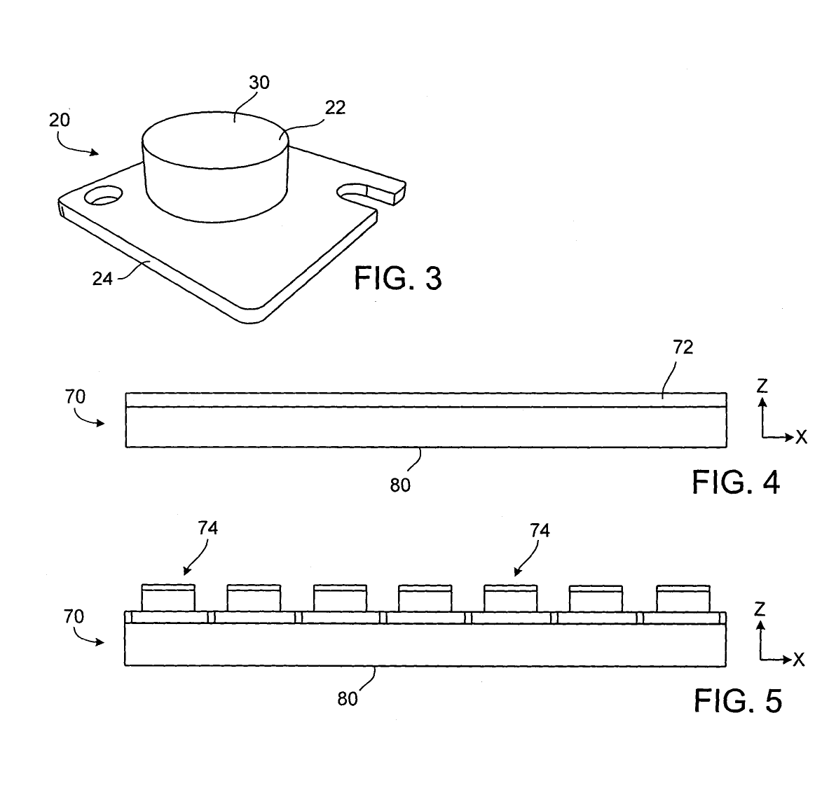

As shown in FIG. 2, a flash module 20 is integrated into the housing 28 of an electronic device such as a smartphone. Various components of the electronic device, including the flash module, are contained within housing 28. Flash module 20 includes a light guide 22 mounted on a transparent base plate 24 and also includes an active light emitting component (e.g., a light emitting diode (LED)) 26. The sidewall surface(s) 40 of light guide 22 are coated with at least two layers: a first, inner layer 42 to enhance the aesthetic appearance of the smartphone and a second, outer non-transparent layer 44 for light blocking purposes. Such dual coating layers can help prevent light from LED 26 from leaking into housing 28 and at the same time help maintain or enhance the outer appearance of the smart phone or other device. Furthermore, if a white coating is used for the inner layer, such a coating can help improve performance of the flash, by enhancing the amount of light from LED 26 that is reflected out of the module.

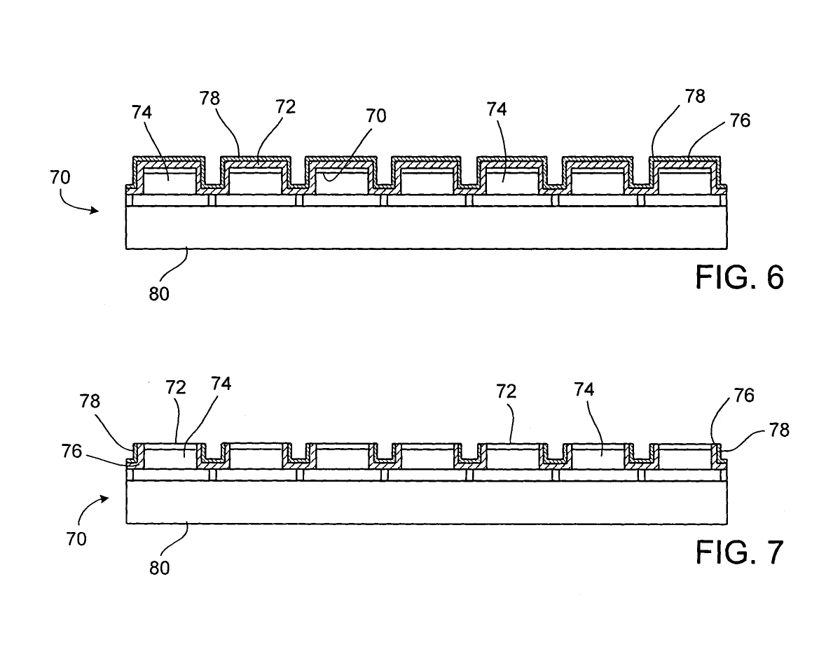

As shown in FIG. 3, light guide 22 can have, for example, a cylindrical shape. In that case, housing 28 can have a circular opening (e.g., a through-hole) that has a diameter just slightly larger than the diameter of light guide 22 so that the light guide fits into the opening of housing 28. The surface 30 of light guide 22 that is farther away from base plate 24 can be substantially flush with an exterior surface 32 of housing 28 such that surfaces 30 and 32 are in substantially the same plane. A lens element 34 is attached on the side of base plate 24 closer to LED 26, which is surrounded by a casing 36. LED 26 can be mounted, for example, on an inner surface of casing 36 such that its main emission axis 38 is substantially aligned with lens element 34 and light guide 22. Thus, casing 36 serves as a housing having an interior region in which LED 26 and lens element 34 are located.

Casing 36 can be formed, for example, as a unitary piece or may comprise two or more parts. It can help ensure a precise and constant relative positioning of LED 26 with respect to the optical system (i.e., lens element 34, base plate 24 and light guide 22) both, laterally and vertically. The vertical direction (designated as z in FIG. 2) is the direction perpendicular to base plate 24; the lateral directions are the directions in the plane defined by base plate 24 (i.e., directions x and y in FIG. 2).

Casing 36 can be laterally positioned relative to the optical system by means of one or more mechanical guiding elements (e.g., a guiding pin of casing 36 can interact with a hole in base plate 24). Vertical alignment can be achieved by the vertical extension of casing 36, with LED 26 attached thereto in a well-defined and precise vertical position. The lateral position of LED 26 in casing 36 should be well-defined and precise as well. The optical system (i.e., lens element 34, base plate 24 and light guide 22) can be attached to the housing 28 of the electronic device (e.g., smartphone) and to the casing 36 of the flash module, respectively, for example, by threads, windings or a snap fit. In some implementations, the optical system can be attached to housing 28 and/or casing 36, at least in part, by gluing, such as by applying an epoxy glue and hardening the glue, for example, by curing (e.g., by radiation or thermal curing).

Light guide 22 and lens element 34 define respective axes (e.g., a central axis of light guide 22 and an optical axis of lens element 34), which can be aligned vertically such that the axes substantially coincide. Likewise, LED 26 describes an axis (e.g., its main direction of light emission), which also can coincide with the axes of light guide 22 and lens element 34. A (central) path of light to or from LED 26 thus runs along an axis through lens element 34, base plate 24 and light guide 22. Light guide 22 thus provides an optical channel from the flash module through housing 28 of smartphone or other device.

Base plate 24 can be made, for example, of an injection-molded polymer that is substantially transparent to light emitted by active light emitting component 26. The material of base plate 24 can be selected to be transparent at least to a particular wavelength or range of wavelengths (e.g., in the visible range). Suitable polymers include, for example, polycarbonate or poly(methyl methacrylate) (PMMA). Lens element 34 can be, for example, a diffractive lens, a refractive lens, or a refractive and diffractive lens. In some implementations, lens element 34 can comprise two or more lenses, and may use of total internal reflection (TIR). Lens element 34 can be made, for example, of a replication material such as a cured material (e.g., a UV-curable or a heat-curable polymer). In some implementations, the light guide 24 is composed of a glass material.

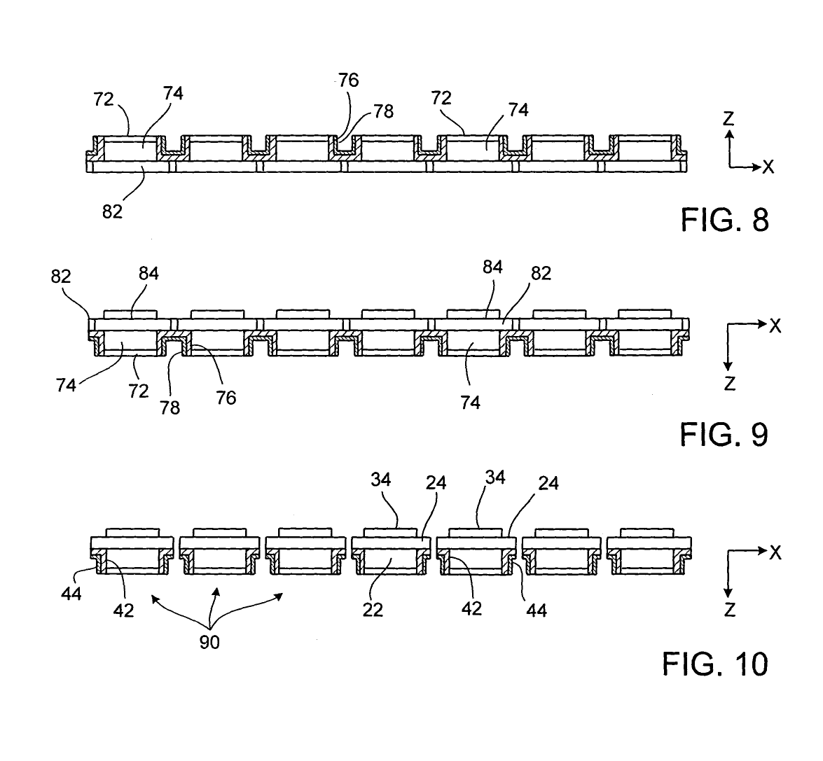

FIGS. 4 through 11 illustrate an example of a wafer-level fabrication process for manufacturing multiple optical systems, each of which includes a lens element 34, a base plate 24, and a light guide 22 whose sidewall surfaces are coated with an inner layer to enhance aesthetic appearance (e.g., of the smartphone) and an outer non-transparent layer for light blocking purposes.

In the illustrated example, the wafer-level process begins with a blank wafer 70, which can include a coating 72 such as an anti-scratch and/or an anti-smudge coating. Blank wafer 70 then is processed, for example, by micro-machining (e.g., milling) to form light guiding elements 74. An example is shown in FIG. 5. Light guiding elements 74 can have, for example, a cylindrical shape.

Next, as illustrated in FIG. 6, first and second coatings 76, 78 are applied to the side and top walls of light guiding elements 74. The first, or inner, coating layer 76 can have a white or colored (i.e., non-white) appearance and can be composed, for example, of a polyurethane-type material. The color of inner coating layer 76 can be selected to provide a desired aesthetic appearance. For example, in some implementations, the color of coating layer 76 can be selected to match the color of the outer surface 32 of phone housing 28. If a white coating layer 76 is used, this can help increase the amount of light from the LED that is reflected out of the module. The second, or outer, coating layer 78 should be substantially non-transparent to light emitted by LED 26 and can be composed, for example, of a polymer resist-type material, a metallic material (e.g., aluminum) or a black chromium material. The two coating layers 76, 78 can be applied sequentially, for example, using PVD, CVD, dip coating, spray coating, sputtering or evaporation techniques. The thickness of the coating layers 76, 78 depends on the implementation, but preferably each coating layer has a thickness in the range of about 5-40 microns (gm) and, in some implementations, one or both of the coating layers have a thickness in the range of about 10-20 μm. After depositing the coating layers 76, 78, baking (i.e., heating at an elevated temperature) is performed.

After depositing and baking the coating layers 76, 78, the portions of the coating layers over the top surfaces of light guiding elements 74 are removed using, for example, photolithographic, chemical or mechanical techniques. In this context, the top surface of the light guiding element from which the coating layers are removed refers to the surface that is substantially parallel to the flat, bottom face 80 of wafer 70. If a photolithographic technique is used, a photolithographically structurable coating (e.g., a photoresist coating) can be used. If a chemical technique is used, an appropriate solvent can be provided to etch away coating layers 76, 78 from the top surface of light guiding elements 74. In some implementations, coating layers 76, 78 are removed from the top surfaces of light guiding elements 74 mechanically by applying a tape having an adhesive surface. Depending on the technique used to apply coating layers 76, 78, material also can be removed from the flat, bottom face 80 of wafer 70. After removal of coating layers 76, 78 from the top surfaces of light guiding elements 74, the sidewalls of the light guiding elements remain covered with both coating layers 76, 78, as shown in FIG. 7.

In the foregoing example, both coating layers 76, 78 are applied sequentially and, following baking, the portions of the both coatings over the top surfaces of light guiding elements 74 are removed in the same removal step. However, in some implementations, the first coating layer 76 can be applied, followed by baking and removal of the portions of the first coating layer that are over the top surfaces of light guiding elements 74. After removal, of first coating layer from the top surfaces of light guiding elements 74, second coating layer 78 is applied (followed by baking and removal of the portions of the second coating layer that are over the top surfaces of light guiding elements 74). In either case, anti-scratch and/or anti-smudge coating 72 should not be removed, but should remain over the top of light guiding elements 74.

In some implementations, it may desirable to add a third coating layer over second coating layer 78. The third coating layer can have, for example, the same or similar properties as first coating layer 76. Such a third coating layer can be applied using the techniques as described above (followed by baking and removal from the top surfaces of light guiding elements 74).

If anti-scratch and/or anti-smudge coating 72 was not previously applied to the top faces of light guiding elements 74, such a coating can be applied at this point in the fabrication process.

In some implementations, wafer 70 is thinned from its back face 80. Such thinning can be accomplished, for example, by lapping and can help achieve a higher precision in thickness of the base plate substrate 82. Furthermore, removal of undesired coatings that may be present on the back face 80 of wafer 70 can be achieved simultaneously. When polishing or machining is carried out, the surface quality and/or optical quality may be improved as well. An example of the thinned wafer 82 is illustrated in FIG. 8.

Next, as shown in FIG. 9, lens elements 84 are applied to the back face of the thinned wafer 82 (i.e., the side of the wafer opposite the side on which light guiding elements 74 are disposed). Formation of light guiding elements 74 can be accomplished with high precision, for example, using a replication technique such as embossing. In other implementations, a liquid glue can be applied to the back face 80 of wafer substrate 82 or to pre-fabricated lenses, which then are placed on the back face of the wafer, for example, by pick-and-place equipment.

In the embossing process, multiple lens elements 84 can be produced on wafer substrate 82 at the same time. A replication tool or stamp used for producing the lens elements 84 can be, with respect to the position of the lens elements, specifically adapted to the position of the light guiding elements according to the mold used in the injection molding. Such a process can enhance yield and precision. For example, a mold can be fabricated and then the positions corresponding to the light guiding elements are measured at the mold itself. Alternatively, a wafer is produced by injection molding using that mold, and then the positions of the light guiding elements are measured at the resulting wafer. Then, a replication tool such as a stamp for the manufacture of the lens elements is manufactured, e.g., using recombination, wherein the positions for the lens elements 84 are chosen based the measurements carried out at the mold. Accordingly, the replication tool can be designed such that each lens element 84 is aligned properly with respect to a light guiding element, and positional errors and imprecisions of the mold are reproduced in the replication tool.

Next, the resulting wafer of optical systems is separated into individual optical systems 90, each of which includes a lens element 34, a base plate 24, and a light guide element 22 whose sidewall surfaces are coated with an inner layer 76 to enhance aesthetic appearance (when assembled as part of an electronic device such as a mobile phone) and an outer non-transparent layer 78 for light blocking purposes. The wafer of optical systems can be separated into distinct optical systems, for example, by dicing using laser cutting or sawing. After singulation, each optical system includes a lens element 34 that is aligned with respect to a light guiding element 22. The foregoing wafer-level process can, in some implementations, provide multiple optical systems 90 in high precision, with high yield and high throughput in the manufacturing process.

The wafer-level process can result in the simultaneous fabrication of tens, hundreds or even a greater number of optical systems 90.

Each optical system 90 then can be assembled, for example, as part of a flash module (see, e.g., flash module 20 in FIG. 2) by attaching the optical system to a casing 36 as shown, for example, in FIG. 2. Flash module 20 then can be integrated into an electronic device such as smartphone or other mobile phone. In such devices, space often is at a premium. Thus, it is important that the optical system 90 arranged therein be small.

In some implementations, lateral dimensions of base plates 24 are less than 10 mm, and preferably less than seven 7 mm, and vertical dimensions are less than 0.6 mm, and preferably less than 0.4 mm. Lateral dimensions of light guiding elements 22 can be, for example, less than 5 mm, and preferably less than 3.5 mm, and vertical dimensions can be, for example, less than 3 mm, and preferably less than 2 mm. Lateral dimensions of lens elements 34 can be, for example, less than 5 mm, and preferably less than 3.5 mm and vertical dimensions can be, for example, 1.5 mm, and preferably less than 1 mm.

Optical systems 90 can have not only high precision and excellent optical properties, but also can be positioned in an electronic device with high precision by using integrated mechanical guiding elements as discussed above. The amount of space consumed by an optical system 90 in an electronic device (e.g., smartphone) can be extremely small, and high-volume mass production can be achieved.

In some implementations, flash module 20 is integrated as part of another type of electronic device such as a photographic device.

Although particular embodiments are described above, various modifications can be made. Thus, other implementations are within the scope of the claims.

1. A flash module comprising:
an optics portion including:
a base plate;
a light guide on a first side of the base plate; and
a lens element on a second side of the base plate;
a casing attached to the optics portion and defining an interior region in which the lens element is located; and
an active light emitting component mounted within the casing,
wherein sidewalls of the light guide are coated with first and second layers of different materials, wherein the second layer is a coating over the first layer and is substantially non-transparent to light emitted by the active light emitting component.

2. The flash module of claim 1 wherein a main emission axis of the active light emitting component is substantially aligned with a central axis of the light guide and an optical axis of the lens element.

3. The flash module of claim 1 wherein the first layer provides a predetermined aesthetic appearance.

4. The flash module of claim 1 wherein the first layer has a white appearance.

5. The flash module of claim 1 wherein the first layer has a colored appearance.

6. The flash module of claim 1 wherein the first layer is composed of a polyurethane-type material.

7. The flash module of claim 1 wherein the second layer is composed of a polymer resist-type material.

8. The flash module of claim 1 wherein the second layer is composed of a metallic material.

9. The flash module of claim 1 wherein the second layer is composed of a black chromium material.

10. The flash module of claim 1 wherein the first layer has a thickness in a range of 5-40 microns.

11. The flash module of claim 1 wherein the first layer has a thickness in a range of 10-20 microns.

12. The flash module of claim 1 wherein the second layer has a thickness in a range of 5-40 microns.

13. The flash module of claim 1 wherein the second layer has a thickness in a range of 10-20 microns.

14. The flash module of claim 1 wherein the first side of the base plate, other than an area on which the light guide is disposed, is coated with the first and second layers.

15. The flash module of claim 1 wherein the active light emitting component is a light emitting diode, and wherein the base plate is substantially transparent to light emitted by the light emitting diode, which is mounted on an inner surface of the casing.

16-41. (canceled)
